(19) United States
(12) Patent Application Publication
(10) Pub. No.: US 2011/0242721 A1
(43) Pub. Date: Oct. 6, 2011

(54) ELECTRONIC DEVICE WITH SAFETY TESTING FUNCTION

(75) Inventors: YANG-YUAN CHEN, Tu-Cheng (TW); HENG-CHEN KUO, Tu-Cheng (TW)

(73) Assignee: HON HAI PRECISION INDUSTRY CO., LTD., Tu-Cheng (TW)

(21) Appl. No.: 12/792,690

(22) Filed: Jun. 2, 2010

(30) Foreign Application Priority Data
Mar. 30, 2010 (TW) 99109741

(51) Int. Cl. H02H 3/22

(52) U.S. Cl. 361/131

(57) ABSTRACT

An electronic device includes a lightning protection circuit, a DC power unit, a housing, and a safety test switching device. The lightning protection circuit includes a circuit board, a fire wire, a ground wire, an AC power unit, and at least two protection elements. Both the fire wire and the ground wire are coupled to the DC power unit and the AC power unit. The housing includes a bottom board. The circuit board is disposed on the bottom board. The safety test switching device includes a conduction block formed on the circuit board and a conductive plug. The conduction block defines a threaded hole. The conductive plug is detachably plugged into the conductive block, when the conductive plug is detached from the conductive block, the lightning protection circuit and the ground are an open circuit.

### BACKGROUNDS

1. Technical Field

The present disclosure generally relates to electronic devices and, particularly, to an electronic device with convenient safety testing function.

2. Description of Related Art

Generally, before shipment, many electronic devices undergo safety test to ensure standards of quality have been met. Those electronic devices also have each been equipped with at least one lightning protection member, such as varistors, configured for leading a surge voltage generated by a lightning strike to the ground, thereby to protect the electronic device from being burned out. The safety testing method is providing a Hi-pot tester applying a high voltage power on the electronic device for testing voltage withstanding. However, when a high voltage power is applied to the electronic device, if the lightning protection member has not been disabled, the lightning protection member still works to lead the high voltage power to the ground, which can lead to failure of the safety test.

To avoid the problem mentioned above, in the past, shearing the pins of the lightning protection members to disable the lightning protection members was done before the safety test, and after the safety test was finished, rejoining the pins to the lightning protection members was needed. However, this kind of safety test process is time consuming.

Therefore, it is desirable to provide an electronic device which can overcome the above mentioned problems.

### BRIEF DESCRIPTION OF THE DRAWINGS

Many aspects of the present electronic device can be better understood with reference to the accompanying drawings. The components in the drawings are not necessarily drawn to scale, the emphasis instead being placed upon clearly illustrating the principles of the present electronic device. Moreover, in the drawings, like reference numerals designate corresponding parts throughout the several views, and all the views are schematic.

FIG. 1 is a schematic view of an electronic device according to an exemplary embodiment.

FIG. 2 is a schematic view of a lightning protection circuit of the electronic device of FIG. 1.

### DETAILED DESCRIPTION

Embodiments of the present electronic device will now be described in detail below and with reference to the drawings.

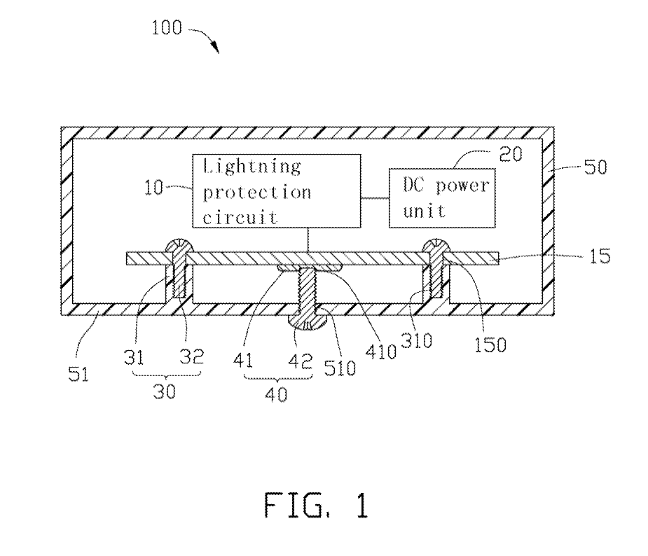

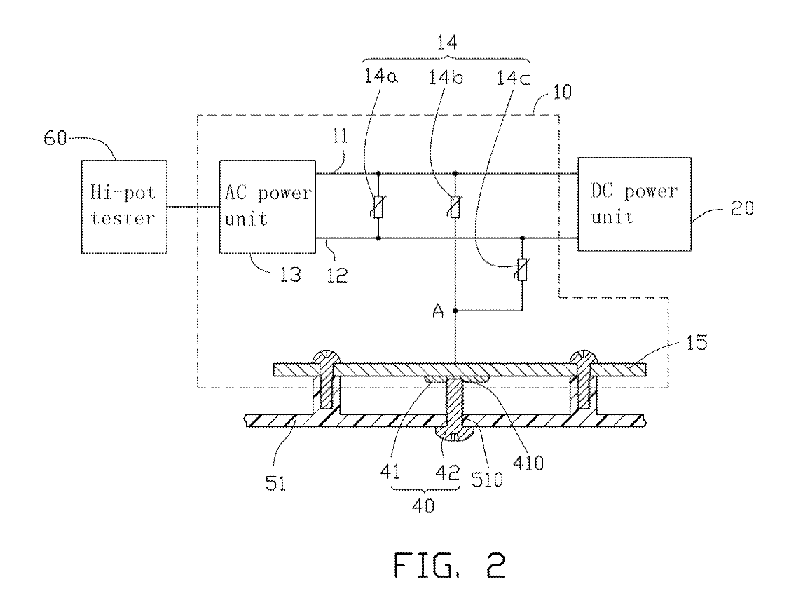

Referring to FIGS. 1 and 2, an electronic device 100 includes a lightning protection circuit 10, a Direct Current (DC) power unit 20, a supporting device 30, a safety test switching device 40, and a housing 50 for receiving the lightning protection circuit 10, the DC power unit 20, the supporting device 30, and the safety test switching device 40 therein.

The lightning protection circuit 10 includes a fire wire 11, a ground wire 12, an Alternating Current (AC) power unit 13, at least two lightning protection elements 14, and a circuit board 15. Both inputs of the fire wire 11 and the ground wire 12 are coupled to the AC power unit 13, and both outputs of the fire wire 11 and the ground wire 12 are coupled to the DC power unit 20. In the present embodiment, the lightning protection circuit 10 includes three lightning protection elements 14 respectively named as a first lightning protection element 14a, a second lightning protection element 14b, and a third lightning protection element 14c. The first lightning protection element 14a is connected between the fire wire 11 and the ground wire 12. The second lightning protection element 14b and the third lightning protection element 14c are serially connected between the fire wire 11 and the ground wire 12, a node A formed between the second lightning protection element 14b and the third lightning protection element 14c is connected to the circuit board 15. In this embodiment, the lightning protection elements 14 are varistors had a high resistance at low voltages and a low resistance at high voltages. The operating principle of the lightning protection elements 14 is that: when a surge voltage generated by lightning is applied to the first, second and third lightning protection elements 14a, 14b, 14c, the first, second and third lightning protection elements 14a, 14b, 14c have not been disabled.

In an alternative embodiment, the first lightning protection element 14a or the second lightning protection element 14b may be omitted.

The housing 50 includes a bottom board 51. The bottom board 51 defines a first threaded hole 510 penetrating through the bottom board 51.

The supporting device 30 includes a plurality of supporting columns 31 extending upward from the bottom board 51 of the housing 50, and a plurality of bolts 32. In this embodiment, the supporting column 31 and the bottom board 51 are integrated with each other and are made of insulation material. Each of the supporting columns 31 defines a second threaded hole 310. The circuit board 15 defines a plurality of third threaded holes 150 correspondingly to the second threaded hole 310. Each of the bolts 32 is screwed into a corresponding second threaded hole 310 and a corresponding threaded hole 150 to firmly fix the circuit board 15 on the supporting column 31.

The safety test switching device 40 includes a conduction block 41 formed on a surface of the circuit board 15 facing the bottom board 51, and a conductive plug 42 detachably plugged into the conduction block 41. In detail, the conduction block 41 defines a fourth threaded hole 410 aligned with the first threaded hole 510 of the bottom board 51. In this embodiment, the conductive plug 42 is a conductive metal bolt detachably engaged with the first threaded hole 510 and the fourth threaded hole 410.

In use, when the conductive plug 42 is disengaged from the fourth threaded hole 410, that is, when the conductive plug 42 is detached from the conductive block 41, the lightning protection circuit 10 and the ground are an open circuit. When a Hi-pot tester 60 supplies a high voltage power to the AC power unit 13, the AC power unit 13 outputs the high voltage power to the DC power unit 20 via the fire wire 11 and the ground wire 12 for testing voltage withstanding. After the safety testing is finished, the conductive plug 42 is screwed into the fourth threaded hole 410. During the time the electronic device 100 is working, because of a surge voltage caused by the lightning strike. The first lightning protection element 14a, the second lightning protection element 14b, and the third lightning protection element 14c have not been disabled thereby leading the power outputted by the AC power unit 13 to the ground via the circuit board 15 and the conductive plug 42. As a result, the surge voltage generated by the lightning is not applied to the DC power unit 20, thus the electronic device 100 is protected from being burned out by the surge voltage.

It will be understood that the above particular embodiments is shown and described by way of illustration only. The principles and the features of the present invention may be employed in various and numerous embodiments thereof without departing from the scope of the invention as claimed. The above described embodiments illustrate the scope of the invention but do not restrict the scope of the invention.

What is claimed is:

1. An electronic device comprising:
a direct current (DC) power unit;
an lightning protection circuit comprising a circuit board, a fire wire, a ground wire, an alternating current (AC) power unit, and at least two lightning protection elements, both the fire wire and the ground wire coupled between the AC power unit and the DC power unit, and at least one of the at least two lightning protection elements coupled between the fire wire and the ground wire or coupled between the fire wire and the circuit board;
a housing configured for housing the DC power unit and the lightning protection circuit, the housing comprising a bottom board, the circuit board disposed on the bottom board; and
a safety test switching device received in the housing and comprising a conduction block formed on a surface of the circuit board facing the bottom board, and a conductive plug, the conduction block defined a threaded hole, wherein the conductive plug is detachably plugged into the conductive block, when the conductive plug is detached from the conductive block, the lightning protection circuit and the ground are an open circuit.

2. The electronic device of claim 1, wherein the at least two lightning protection elements comprise a first lightning protection element and a second lightning protection element, the first lightning protection element is coupled between the fire wire and the ground wire, the second lightning protection element is coupled between the ground wire and the circuit board.

3. The electronic device of claim 1, wherein the at least two lightning protection elements comprise a first lightning protection element and a second lightning protection element, the first lightning protection element is coupled between the fire wire and the circuit board, the second lightning protection element is coupled between the ground wire and the circuit board.

4. The electronic device of claim 1, wherein the at least two lightning protection elements comprise a first lightning protection element, a second lightning protection element, and a third lightning protection element, the first lightning protection element is coupled between the fire wire and the ground wire, the second lightning protection element and the third lightning protection element are serially coupled between the fire wire and the ground wire, a node formed between the second lightning protection element and the third lightning protection element is coupled to the circuit board.

5. The electronic device of claim 4, wherein when a surge voltage generated due to lightning is applied to the first, the second third lightning protection element, the first, second and third lightning protection elements have not been disable.

6. The electronic device of claim 1, further comprising a supporting device comprising a plurality of supporting column extending upward from the bottom board of the housing, and a plurality of bolts, each of the supporting column defines a second threaded hole, the circuit board defines a plurality of third threaded holes, each of the third hole aligns with a corresponding second threaded hole, each of the bolts is screwed into a corresponding second threaded hole and a corresponding threaded hole to firmly fix the circuit board on the supporting column.

7. The electronic device of claim 6, wherein the bottom board and the supporting column are integrated with each other and are made of insulation material.

8. The electronic device of claim 1, wherein the bottom board of the housing defines a first threaded hole penetrating through the bottom board, the fourth threaded hole aligns with the first threaded hole, the conductive plug is detachably engaged with the fourth threaded hole.
